(19) United States
(12) Patent Application Publication
(10) Pub. No.: US 2005/0222851 A1
(43) Pub. Date: Oct. 6, 2005

(54) Method and system for control of business processes

(76) Inventors: Avaneesh Dubey, Bangalore (IN); Parag Jain, Bangalore (IN)

Correspondence Address: KENYON & KENYON, 1500 K STREET NW, SUITE 700, WASHINGTON, DC, 20005, US

(21) Appl. No.: 10/812,938

(22) Filed: Mar. 31, 2004

(51) Int. Cl. G06F 17/60

(52) U.S. Cl. 705/1; 705/8

(57) ABSTRACT

Embodiments of the present invention relate to configuration and use of business processes in a business application software in terms of generic control elements that model a wide spectrum of business processes.

### FIELD OF THE INVENTION

Embodiments of the present invention relate to software to create a generic framework for the definition of business processes.

### BACKGROUND INFORMATION

In known business application software, user options are often limited by a pre-determined set of assumptions about the user's business processes. That is, the software tends to be designed to carry out a fixed sequence of operations based on a designer's implementation according to his understanding of a user's requirements, and based on a limited set of configuration options. Often, this means that the user's business processes must be adapted to fit the available business application software, rather than the business application software being adapted to fit the user's business processes.

This situation creates evident disadvantages. For example, the software available to a user may not be a good fit to the user's actual needs. This could mean that the user has to take costly and time-consuming “work-around” measures. Moreover, if his business needs change, the user does not have any convenient mechanism for adapting his software to his changing needs.

In view of the foregoing, there is a need for business software that is readily adaptable to a user's business processes.

### SUMMARY OF THE INVENTION

Embodiments of the present invention enable business application software to be readily adapted to a user's business processes, thus avoiding disadvantages associated with the lack of adaptability of prior known software. The embodiments comprise software to implement configuration services based on a flexible and consistent model or framework for the definition of a user's business processes. The software allows a user to define what activities are included in a business process, and to define the behavior of his application software for each activity of the business process, in terms of generic control elements that model a wide spectrum of business processes. The configuration services thereby enable a control mechanism to be defined for any application software so that the software can be easily adapted to its users' practices.

### BRIEF DESCRIPTION OF THE DRAWINGS

FIG. 1A shows an example of a business object and instances of the business object;

FIGS. 1B, 2A and 2B show process flows according to embodiments of the present invention;

FIG. 3 shows an example of a large organization in which embodiments of the present invention might find useful application; and

FIG. 4 shows a system for implementing embodiments of the present invention.

### DETAILED DESCRIPTION

Embodiments of the present invention relate to software to configure business processes on business objects according to a consistent, flexible framework. The framework may provide for definition of a business process to fit any user's particular needs, in terms of activities that have control elements associated with them.

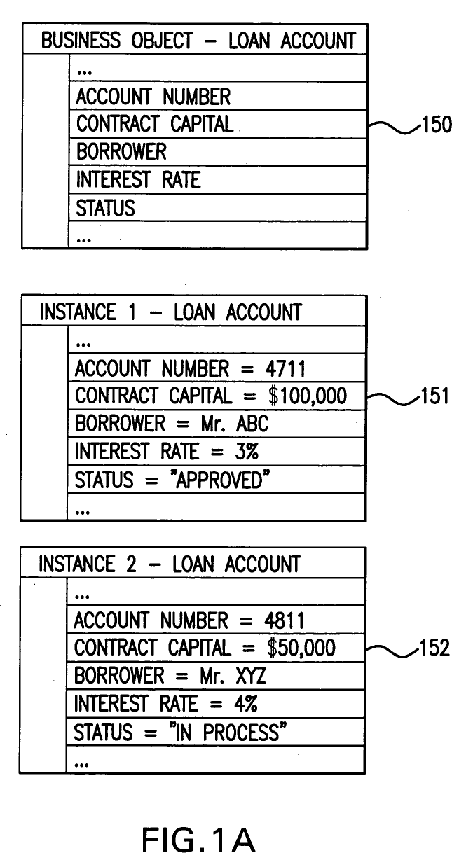

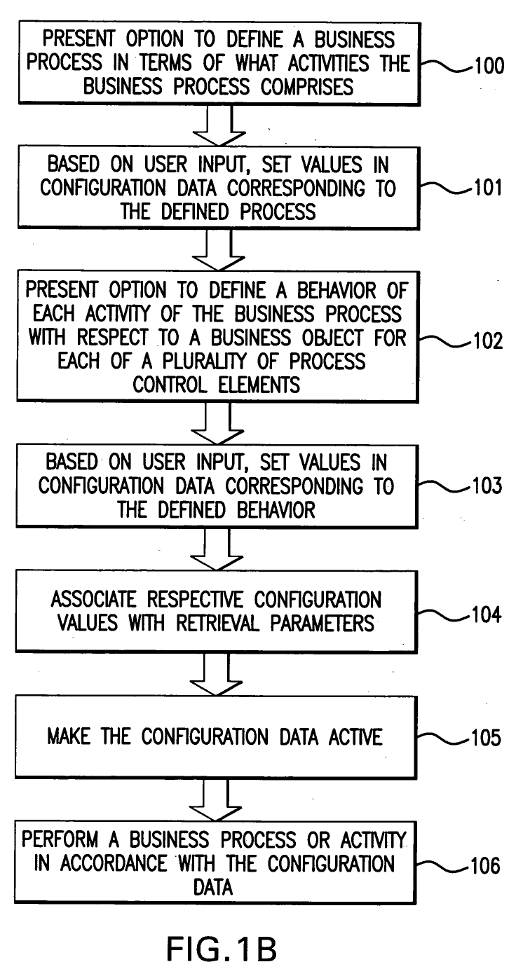

A business process comprises of a series of activities that act on one or more business objects. For example, a loan application process could include some activities to be performed on a loan account, and some activities to be performed on a collateral. In this context, both the loan account and the collateral are business objects. A business object may have a set of attributes that describe the business object. These attributes may take on different values for different “instances” of the object. For example, referring to FIG. 1A, a loan account business object 150 has an attribute “account number”; a first instance 151 of the loan account business object has a specific account number 4711, while a second instance 152 has a specific account number 4811. Attributes of a business object such as “account number,” above, can be changed by a business process via activities of the process.

As another example, assume the business process is the creating and evaluating of a collateral object. This process comprises a sequence of activities affecting the collateral object. An early activity in the process could be the initial collection of data relating to the collateral object from the loan applicant offering the collateral represented by the collateral object. This might typically involve the execution of business application software. The application software could include, for example, computer-executable instructions to generate and enable the manipulation of a user interface of a bank computer by, say, a customer representative in a branch office, to enter and store the initial data.

After the initial data is taken, the initial data might be checked. This activity might be performed by a different person from the person who initially took the data, and could involve the further execution of business application software, the manipulation of an associated user interface, and so on. The check of the initial data may result in a change to the initial data, and consequently a change to the collateral object. Later activities affecting the collateral object could include, for example, a review to assess its value and determine other encumbrances. Following such a review, the collateral object might be further reviewed by a senior person at the bank. Each of the foregoing activities might involve executing software to manipulate the collateral object by means of a user interface, change the collateral object and save it to a machine-readable storage medium such as disk.

The foregoing is only an illustrative example; it would be impossible to exhaustively list all conceivable business activities and associated business objects. However, it may be observed that many business processes such as that described above have elements in common. For example, business processes everywhere nowadays almost always involve manipulating a user interface. Further, as a business object proceeds through stages of a business process, it may be viewed as assuming changing statuses (e.g., initial status, intermediate status, final status). In the collateral process example, the collateral object could be viewed as having an initial status when the initial data is first taken, an intermediate status after the data is checked, and a final status after the collateral object is evaluated.

The information relating to a business object must typically be checked for accuracy and completeness, as noted in the discussion of the collateral object example above. Such a checking activity or other activity might be required in order to allow a business object to proceed from one stage of a business process to another. Designating a business object to be eligible to proceed to a next stage may be viewed as a clearing or releasing operation.

To perform particular activities relating to a business object, often a particular authorization level is required. For example, only a collateral officer might be allowed to override the collateral object's value. Or, a collateral officer of a particular bank branch might be able to view collateral objects of another branch, but not change them.

As noted earlier, the above-described activities, or activities analogous thereto, may be found across a wide spectrum of business processes. Thus, the present inventors have conceived of a general framework or model comprising elements common across this wide spectrum of processes, that may be applied to flexibly define a business process according to a particular user's needs. The framework may comprise the following process control elements: 1) a status element; 2) a user interface element; 3) a plausibility check element; 4) a release element; and 5) an authorization element.

The status control element relates to the status of a business object: that is, to what stage a business process that acts on the object is in, or what activity of the business process is being applied or is to be applied to the object.

The user interface control element relates to the appearance and operability of a user interface for handling a business object, such as which fields are/are not open for user input.

The plausibility check control elements relates to plausibility checks on data relating to the object. For example, the plausibility check control element could relate to whether data entered by the user at one stage of a business process is consistent with data entered at another stage of the process, or whether calculations associated with the business object are correct, or the like.

The release control element relates to the approval for a business object acted on by an activity of a business process to be acted on by a subsequent activity of the business process. For example, to return to the illustration discussed above, the collateral object might have to go through a series of plausibility checks before it is released to a senior officer for review. The release control element could have criteria associated with it and/or have multiple control levels. For example, the release control element might apply criteria to determine who was a correct officer to review the collateral object. An example of multiple control levels is requiring more than one approval based on a collateral object's value.

The authorization element relates to who has permission to do what to a business object. Examples of different kinds of authorization were discussed above in connection with the collateral object.

According to embodiments of the present invention, application software for performing a business process may be configured in accordance with the foregoing process control elements. More specifically, a particular set or sequence of activities may be defined as constituting or being included in a particular business process that acts on an object. For each activity of the business process so defined, a behavior of the activity with respect to the object for each of the process control elements may be defined. Based on the definitions, values in configuration data according to embodiments of the present invention may be set. After the configuration is complete, activities of the configured business process may be performed on an object. The activities may involve executing software on a computer system including storage media containing the configuration data. The software may refer to the configuration data to determine how the object is to be handled.

An example follows of configuring a business process using process control elements in accordance with embodiments of the present invention. Assume that a computer system on which it is expected that the business process will be performed comprises a storage medium such as disk on which as-yet-unconfigured configuration data resides or is to be created and stored. Software according to embodiments of the present invention may be executed on the computer system to configure the data.

Operations by the configuration software may include presenting a user, for example via a user interface comprising a display device, input devices such as a keyboard and mouse, and associated displays with input fields, with a number of configuration options. One such option may be to define what activities constitute a business process; or, put another way, to define a business process in terms of what activities it comprises. Assume that the user defines business process A as comprising activities 1, 2, 3 and 4.

The configuration software may further present the user with the option to define, for each activity of a business process, how the activity is to behave with respect to a business object for each of the process control elements outlined above. Assume in this example that the user is defining behavior of each of activities 1, 2, 3 and 4 with respect to business object A.

To define the desired behavior for a given activity, the user may be enabled to specify particular values relating to respective process control elements. For example, to define the behavior of activity 1 with respect to object A for the authorization element, the user may be enabled to specify who is authorized to perform activity 1 on object A. For the user interface element, the user may be enabled to specify what fields of a user interface for manipulating the object may be filled in or modified. For the status element the user may be enabled to specify the object status on completion of activity 1. The user might proceed in a similar manner to define the behavior of activity 1 for the plausibility check and release elements.

Next, the user may configure activity 2 of business process A. To configure activity 2, the user might, for the plausibility check control element, require that certain values associated with object A are consistent with each other, or the like. For the user interface control element, the user might enable/disable particular fields of a user interface for manipulating object A pursuant to activity 2. Additionally, for the status element, the user might define the pre-requisite status of the status element before the activity could be performed on object A. The user might proceed in a similar manner to define the behavior of activity 2 for the authorization and release elements.

The user might proceed in a similar way to configure activities 3 and 4. Each of the values entered by the user during the configuration process may be saved in configuration data. In embodiments, the configuration values may be stored for a combination of a control key and a process control area that, as explained in more detail further on, may subsequently be used to determine what configuration values are to control a given process. After the values relating to the definition of the business process are saved, further configuration software may be executed to cause the definitions to become active in a computer system that will be used to execute software for performing the business process.

FIG. 1B shows a process flow according to embodiments of the present invention. As shown in block 100, computer-executable instructions of configuration software according to embodiments may present a user with an option to define a business process in terms of what activities the business process comprises. Based on user input entered in response to the presented option, the configuration software may set values corresponding to the defined business process in configuration data stored on a machine-readable medium such as magnetic disk, as shown in block 101.

As shown in block 102, the configuration software may further present a user with an option to define a behavior of each activity of the business process with respect to a business object for each of a plurality of process control elements. The process control elements may comprise at least one of a status element, a user interface element, a plausibility check element, a release element, and an authorization element as described above. Based on user input entered in response to the presented option, the configuration software may set values corresponding to the defined behavior in configuration data stored on a machine-readable medium such as magnetic disk, as shown in block 103.

As shown in block 104, respective configuration values may be associated with retrieval parameters, based upon which the respective configuration values may be read from the configuration information to control respective business processes when the business processes are subsequently performed. As discussed above, in embodiments the retrieval parameters could include a control key and a process control area. These are described in more detail below.

After the configuration values and associated retrieval parameters are recorded in the configuration data, the configuration data may be made active in a computer system that is to be used to perform the associated business processes, as shown in block 105. As shown in block 106, when a business process or activity for which configuration has been done is subsequently performed, the configuration data for the process or activity may consulted, and the associated business object may be processed in accordance with the configuration data.

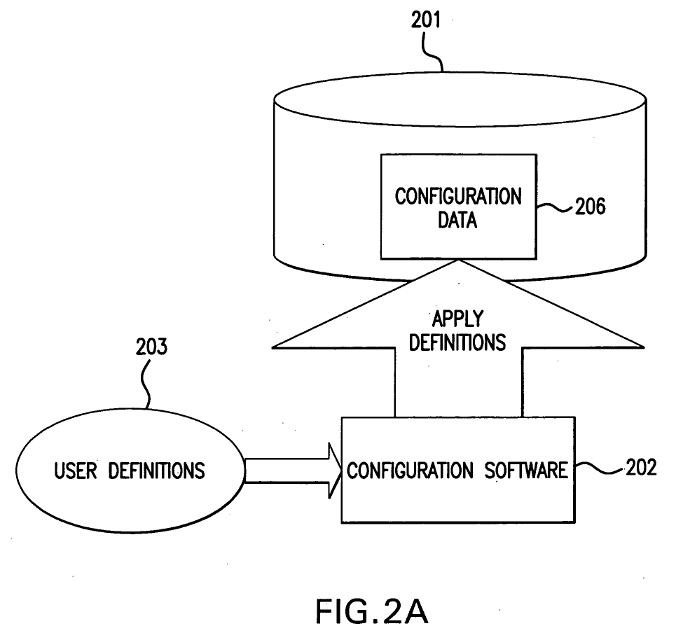

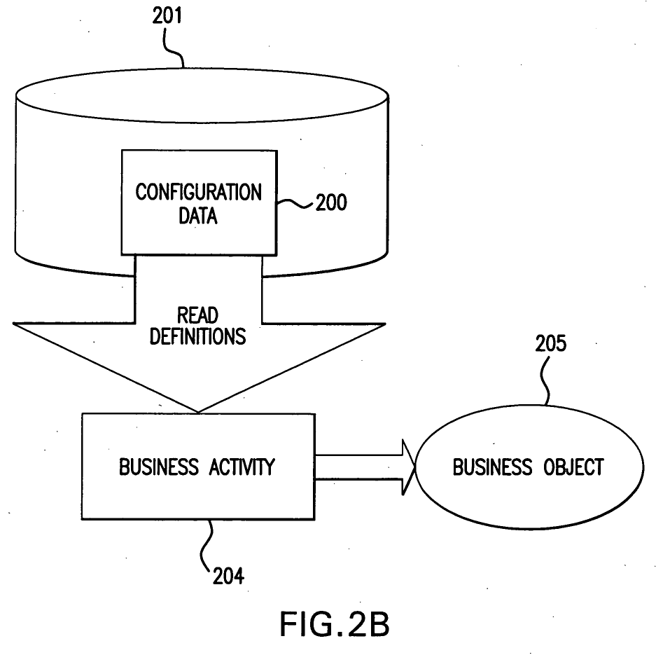

FIGS. 2A and 2B are further illustrations of process flows according to embodiments of the present invention. As shown in FIG. 2A, configuration software 202 according to embodiments may be executed to apply user definitions of a desired behavior of a business process with respect to a business object in accordance with process control elements including a status element, a user interface element, a plausibility check element, a release element, and an authorization element. The configuration software 202 may apply the definitions to set values of configuration data 200 stored on a machine-readable medium 201.

As shown in FIG. 2B, a configured business activity 204 may subsequently be performed. The configuration data 200 may be read to determine how the business activity 204 should behave with respect to a business object 205 acted on by the business activity 204.

It should be understood that the configuration software according to embodiments of the present invention is designed to cooperate with software whose behavior is controllable as described. For example, suppose embodiments of the present invention were to be used to configure software for implementing a collateral management system of a bank. The collateral management system could include the configuration software in its package in order to use the services of the configuration software for managing collateral processes. The collateral management system would be designed to enable control of its processes by the configuration procedure described herein. However, collateral management system software is only one example of business application software that could be configured as described herein. Generally, any kind of functionality could be structured in accordance with the principles described herein to cooperate with a control mechanism implemented by configuration data as described.

Embodiments of the present invention could be particularly useful in large organizations, in part because the configuration data can be used to control various different processes and instances of business objects in the organization. More specifically, according to embodiments, different instances of business objects may be respectively associated with attributes such as an administrative unit and a category. These attributes may in turn be mapped respectively to a control key and a process control area, and these may be used to determine what configuration values control a particular business process.

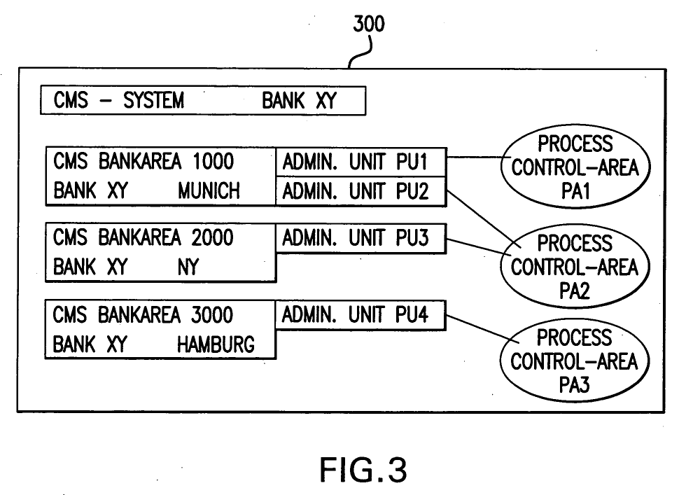

FIG. 3 is an illustration of a large organization, such as a banking system 300. The banking system 300 comprises a collateral management system (CMS) for a bank XY. The CMS comprises three separate divisions: a CMS Bankarea 1000 division in, say, Munich, Germany; a CMS Bankarea 2000 division in, say, New York, USA; and a CMS Bankarea 3000 division in, say, Hamburg, Germany. Each of the divisions has one or more administrative units associated with it: CMS Bankarea 1000 has administrative units PU1 and PU2 associated with it; CMS Bankarea 2000 has administrative unit PU3 associated with it; and CMS Bankarea 3000 has administrative unit PU4 associated with it. The administrative units, in turn, have process control areas associated with them. A given “process control area” may subsume different administrative units that perform the same or similar processes.

Different instances of business objects may further be associated with different respective categories, and the category of a particular instance may also be used to determine what configuration values control the business process that acts on the instance. Categories are arbitrary. Examples of categories in connection with a collateral object as discussed above are a “pledge” category (collateral objects associated with pledges) and a “mortgage” category (collateral objects associated with mortgages).

In view of the foregoing, what configuration values control a particular business process when it is executed on a particular instance of a business object may be based at least in part on an association of the instance with a particular administrative unit and a particular category, and through these associations, with a control key and a process control area. Based on the control key and the process control area associated with an instance of a business object, corresponding configuration values stored for a business process that acts on the instance may be read, and used to control the behavior of the business process.

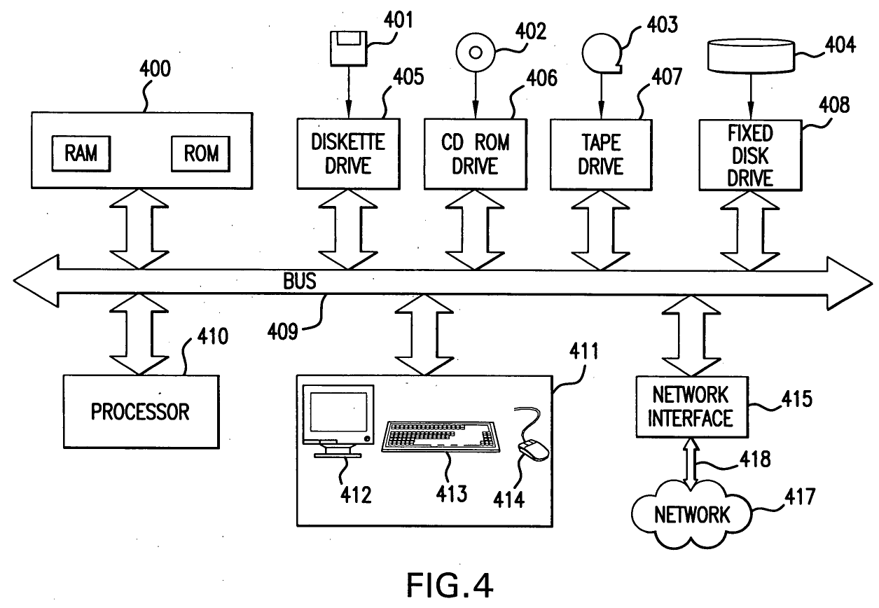

FIG. 4 shows a high-level representation of a computer system for implementing embodiments of the present invention, such as might be realized by a variety of known and commercially available hardware and software elements. The system may comprise a memory 400 including ROM and RAM, processor 410 and user interface 411 comprising a display device 412, keyboard 413 and mouse 414. Elements may communicate via a system bus 409. The system may further comprise a network 417 connected by a network medium 418 and network interface 415.

A computer program or collection of programs comprising computer-executable instructions according to embodiments of the present invention may be stored and transported on machine-readable media such as diskette 401, CD-ROM 402, magnetic tape 403 and fixed disk 404. The computer instructions may be retrieved from the machine-readable media 401-404 using their respective drives 405-408 into memory 400, and executed by a processor 410. The functionality disclosed hereinabove for performing the embodiments may find specific implementations in a variety of forms, which are considered to be within the abilities of a programmer of ordinary skill in the art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. A method comprising:
(i) defining, in configuration data of a computer system, a business process in terms of what activities the business process comprises; and
(ii) defining, in the configuration data, a behavior of each activity of the business process with respect to a business object acted on by the business activity, for a plurality of process control elements including a status element, a user interface element, a plausibility check element, a release element, and an authorization element.

2. The method of claim 1, further comprising performing an activity of the business process in accordance with a corresponding defined behavior.

3. A system comprising:
a processor;
a memory coupled to the processor and storing instructions executable by the processor to configure business application software, the instructions implementing a method including:
presenting an option to define a business process in terms of what activities the business process comprises;
based on user input, setting values in configuration data corresponding to a defined process;
presenting an option to define a behavior of each activity of the business process with respect to a business object for each of a plurality of process control elements including a status element, a user interface element, a plausibility check element, a release element, and an authorization element; and
based on user input, setting values in the configuration data corresponding to a defined behavior.

4. The system of claim 3, the method further comprising performing the business process or an activity thereof in accordance with the configuration data.

5. The system of claim 3, the method further comprising associating respective configuration values with retrieval parameters.

6. The system of claim 5, the method further comprising reading configuration values based on the retrieval parameters, and controlling a behavior of the business process or an activity thereof based on the configuration values.

7. A machine-readable medium storing computer-executable instructions to perform a method comprising:
presenting an option to define a business process in terms of what activities the business process comprises;
based on user input, setting values in configuration data corresponding to a defined process;
presenting an option to define a behavior of each activity of the business process with respect to a business object for each of a plurality of process control elements including a status element, a user interface element, a plausibility check element, a release element, and an authorization element; and
based on user input, setting values in the configuration data corresponding to a defined behavior.

8. The machine-readable medium of claim 7, the method further comprising associating respective configuration values with retrieval parameters.

9. A method comprising:
reading configuration data to determine a behavior of a business activity with respect to a business object, wherein the behavior is defined in the configuration data in accordance with a plurality of process control elements including a status element, a user interface element, a plausibility check element, a release element, and an authorization element; and
performing the business activity in accordance with the configuration data.

10. The method of claim 9, wherein values in the configuration data corresponding to the business activity are read based on a retrieval parameter corresponding to a process control area of the business activity.

11. The method of claim 9, wherein the status element relates to a stage of a business process that includes the business activity.

12. The method of claim 9, wherein the user interface element relates to at least one of an appearance and operability of a user interface for handling the business object.

13. The method of claim 9, wherein the plausibility check element relates to plausibility checks on data relating to the business object.

14. The method of claim 9, wherein the release element relates to an approval for the business object to be acted on by a subsequent activity.

15. The method of claim 9, wherein the authorization element relates to relates an authorization to act on the business object.
